(19) United States
(12) Patent Application Publication
(10) Pub. No.: US 2026/0336502 A1
(43) Pub. Date: Oct. 29, 2026

(54) PICKUP TRUCK BED CAMPER

(71) Applicant: Aaron Hayes, Hinton (CA)

(72) Inventor: Aaron Hayes, Hinton (CA)

(21) Appl. No.: 19/193,262

(22) Filed: Apr. 29, 2025

(51) Int. Cl. B60P 3/34; B60J 1/08; B60J 5/10; B60N 3/00; B60N 3/16; B60R 7/02; B60R 15/02

(52) U.S. Cl. CPC B60P 3/34; B60J 1/08; B60J 5/10; B60N 3/008; B60N 3/16; B60R 7/02; B60R 15/02

(57) ABSTRACT

A camper apparatus for use on a truck bed of a pickup truck includes an enclosure which defines an interior space therein and is shaped and configured to conform to the truck bed of the pickup truck. A stove is mounted in the interior space of the enclosure, and a stove cover is mounted atop the stove. The stove cover is movable between a covered position and an open position. The stove cover is positioned to cover the stove when in the covered position and to expose the stove when in the open position.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to campers and more particularly pertains to a new camper for use on a truck bed of a pickup truck.

### (2) Description of Related Art Including Information Disclosed Under 37 CFR 1.97 and 1.98.

Various campers are disclosed by the prior art which may be used in a truck bed of a pickup truck. However, the prior art fails to describe such an apparatus which includes a stove, a stove cover which selectively covers the stove, and a wash system for supplying water into a sink and draining it from the sink.

### (h) BRIEF SUMMARY OF THE INVENTION

An embodiment of the disclosure meets the needs presented above by generally comprising an enclosure which defines an interior space therein and is shaped and configured to conform to a truck bed of a pickup truck. The enclosure comprises a main section which is sized and configured to fit between a cab of the pickup truck and a tailgate of the pickup truck when the tailgate is in an upright position. A stove is mounted in the interior space of the enclosure, and a stove cover is mounted atop the stove. The stove cover is movable between a covered position and an open position. The stove cover is positioned to cover the stove when in the covered position and to expose the stove when in the open position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective exploded in-use view of a camper apparatus according to an embodiment of the disclosure.

FIG. 2 is a side in-use view of an embodiment of the disclosure.

FIG. 3 is a cross-sectional view of an embodiment of the disclosure taken from Line 3-3 in FIG. 2.

FIG. 4 is a back in-use view of an embodiment of the disclosure.

FIG. 5 is a cross-sectional view of an embodiment of the disclosure taken from Line 5-5 in FIG. 3.

FIG. 6 is a cross-sectional view of an embodiment of the disclosure taken from Line 6-6 in FIG. 3.

FIG. 7 is a cross-sectional view of an embodiment of the disclosure.

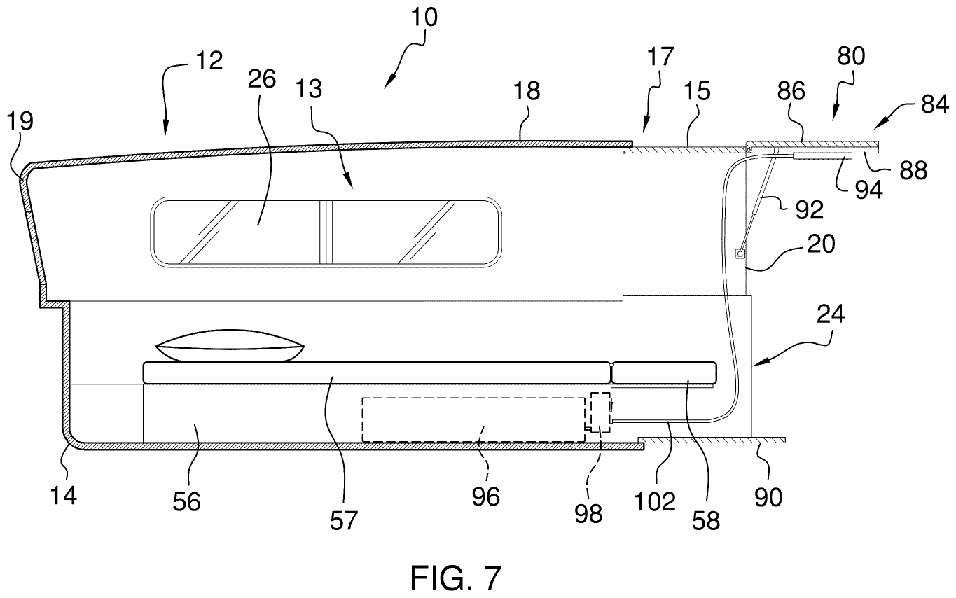

### (j) DETAILED DESCRIPTION OF THE INVENTION

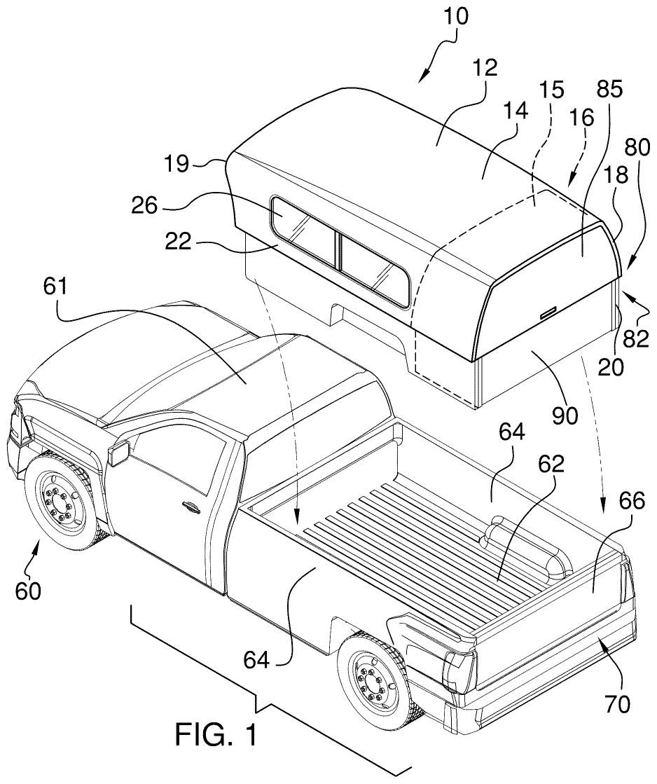

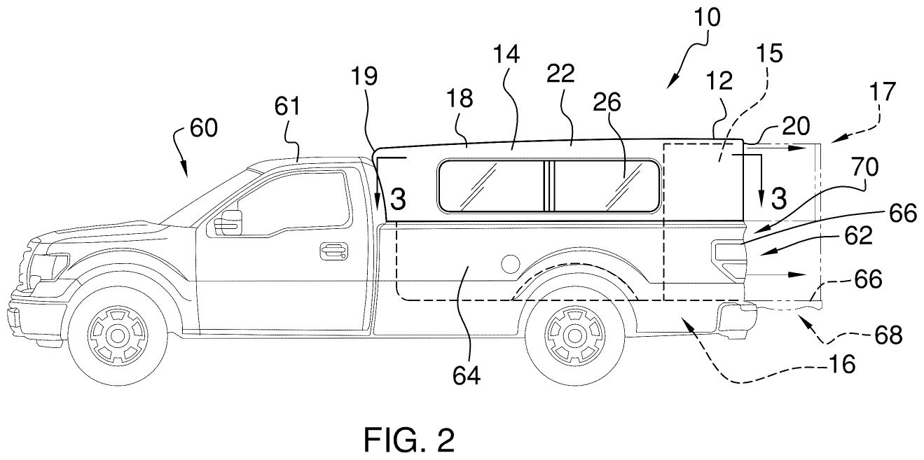

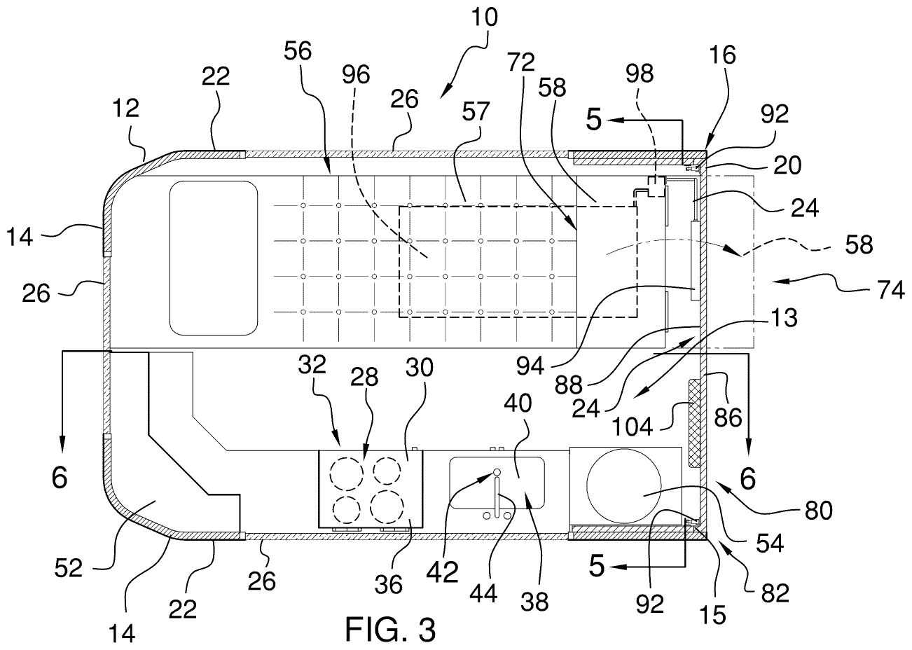

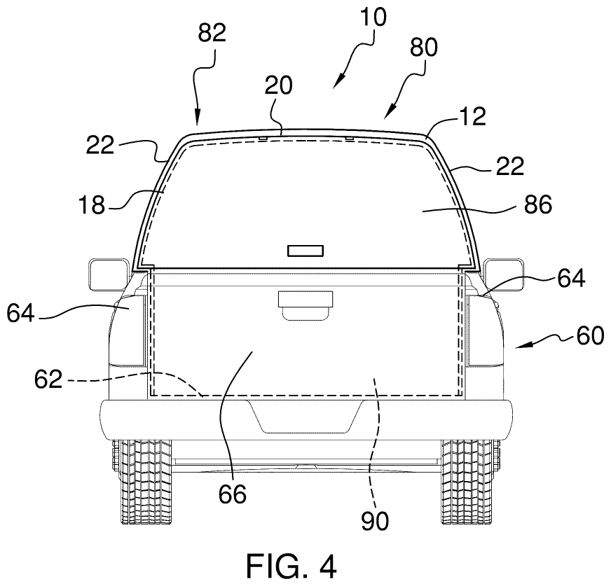

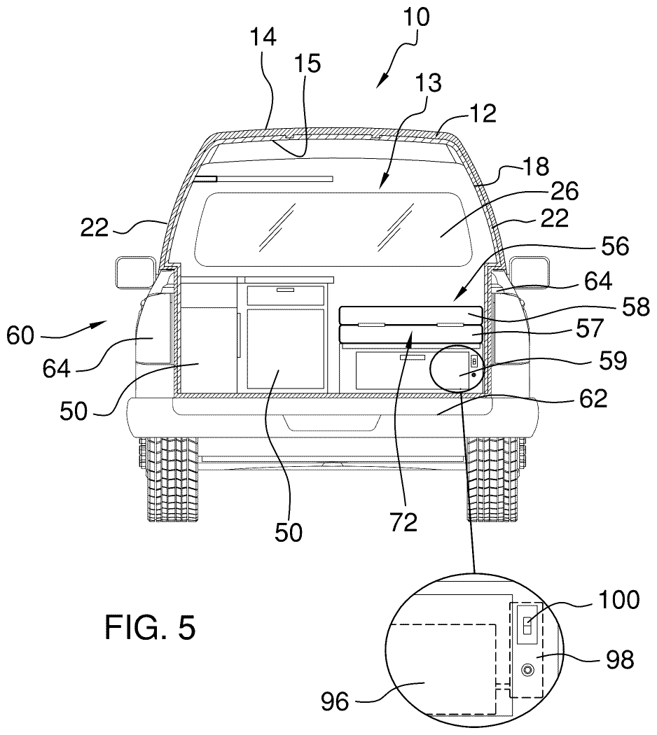

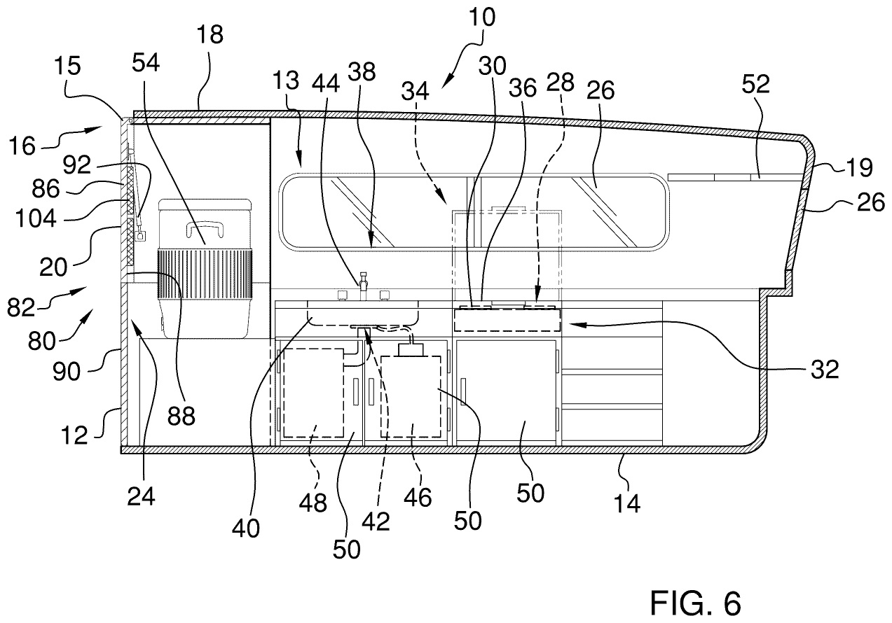

With reference now to the drawings, and in particular to FIGS. 1 through 6 thereof, a new camper embodying the principles and concepts of an embodiment of the disclosure and generally designated by the reference numeral 10 will be described.

As best illustrated in FIGS. 1 through 6, the camper apparatus 10 generally comprises an enclosure 12 which defines an interior space 13 therein and is shaped and configured to conform to a truck bed 62 of a pickup truck 60. The enclosure 12 comprises a main section 14 and an extension section 15. The main section 14 is sized to fit between a cab 61 of the pickup truck 60 and a tailgate of the pickup truck 60 when the tailgate is in an upright position 70. The extension section 15 is slidably coupled to the main section 14 such that the extension section 15 may slide between a stored position 16 in which the extension section 15 is stored within the main section 14 and an extended position 17 in which the extension section 15 extends rearwardly from the main section 14. The extension section 15 may be positioned in the extended position 17 by lowering the tailgate from the upright position 70 to a lowered position 68. An upper portion 18 of the main section 14 of the enclosure 12 is shaped and configured to rest atop and extend a full length of a pair of sidewalls 64 of the truck bed 62.

An access door assembly 80 is coupled at a back side 20 of the enclosure 12 and is slidable laterally with respect to the enclosure 12 to selectively facilitate access to the interior space 13 of the enclosure 12. A plurality of windows 26 is coupled to the upper portion 18 of the main section 14 of the enclosure 12. Each one of a front side 19 and a pair of lateral sides 22 of the enclosure 12 includes an associated window 26 of the plurality of windows 26.

An access door assembly 80 is coupled at a back side 20 of the enclosure 12 and is movable between a closed configuration 82 and an open configuration 84 with respect to an opening 24 which extends through the back side 20 of the enclosure 12 to the interior space 13. The access door assembly 80 comprises an upper door 86 and a lower door 90, wherein the upper door 86 is pivotably mounted to the extension section 15 of the enclosure 12 and the lower door 90 is pivotably mounted to the main section 14 of the enclosure 12. The upper door 86 and the lower door 90 are mounted such that the access door assembly 80 may be moved from the closed configuration 82 to the open configuration 84 by pivoting the lower door 90 downwardly away from the opening 24 and pivoting the upper door 86 upwardly away from the opening 24. Because the lower door 90 is mounted to the main section 14 of the enclosure 12, the lower door 90 may be set atop the tailgate 66 of the pickup truck 60 when the tailgate 66 is in the lowered position 68. The extension section 15 of the enclosure 12 may then be extended over the tailgate 66 and the upper door 86 may be raised to extend rearwardly with respect to the enclosure 12 past the lower door 90. Gas springs 92 couple the upper door 86 to the enclosure 12 and are tuned to retain the upper door 86 away from the opening 24 until the upper door 86 is closed with a sufficient force to overcome the gas springs 92. Other retaining mechanisms may be used to keep the upper door 86 spaced from the opening 24 in other embodiments.

A showerhead 94 is coupled to an interior side 88 of the upper door 86 of the access door assembly 80 and is oriented to face downwardly when the upper door 86 is spaced away from the opening 24 of the enclosure 12 via the gas springs 92 or other retaining mechanism. A shower reservoir 96 is positioned in the interior space 13 of the enclosure 12. A shower pump 98 is mounted to the shower reservoir 96 and is operable via an input 100 to selectively urge water from the shower reservoir 96 to the showerhead 94 via a flexible hose 102. In some embodiments, a rigid tube may be releasably connectable to the shower pump 98 and the showerhead 94 or tubing with sufficient moving parts to allow for movement of the upper door 86 may be used to couple the shower pump 98 to the showerhead 94. The flexible hose 102 also may be releasably coupled to the shower pump 98 and the showerhead 94.

A pocket 104 is mounted to the interior side 88 of the upper door 86. The pocket 104 may have an open end which faces upwardly with respect to the enclosure 12 when the upper door 86 lies against the opening 24 of the enclosure 12. A drawstring, closure flap, a zipper, or another closure mechanism may be coupled to the pocket 104 near the open end to prevent items from falling out of the open end of the pocket 104 when the upper door 86 is lifted away from the opening 24 of the enclosure 12.

A stove 28 is mounted in the interior space 13 of the enclosure 12, and a stove cover 30 is mounted atop the stove 28. The stove cover 30 is pivotable between a covered position 32 and an open position 34 with respect to the stove 28. The stove cover 30 is positioned to cover the stove 28 when in the covered position 32 and is positioned to expose the stove 28 when in the open position 34. The stove cover 30 has a support surface 36 which faces upwardly when the stove cover 30 is positioned in the covered position 32 such that items may be supported atop the support surface 36 of the stove cover 30. The stove 28 may be operated by a power source stored in the enclosure 12 or may be configured to electrically couple to an external power source. Controls are provided for operating the stove 28.

A wash system 38 is mounted in the interior space 13 of the enclosure 12 and comprises a sink 40, a faucet 44, a wash water supply vessel 46, and a used water vessel 48. The faucet 44 is mounted over the sink 40. The wash water supply vessel 46 is in fluid communication with the faucet 44, and the faucet 44 is operable to selectively allow water to flow from the wash water supply vessel 46 through the faucet 44 into the sink 40. The used water vessel 48 is in fluid communication with a drain 42 of the sink 40. Both the used water vessel 48 and the wash water supply vessel 46 are positioned under the sink 40. Water may drain via gravity into the used water vessel 48. Water may be moved from the wash water supply vessel 46 to the faucet 44 via a pump, compressed air housed in the wash water supply vessel 46, or another suitable means.

A plurality of cabinets 50 is mounted in the enclosure 12, and each one of the wash water supply vessel 46 and the used water vessel 48 is housed by an associated cabinet 50 of the plurality of cabinets 50. Shelves 52 and a countertop are also mounted in the interior space 13 of the enclosure 12. An auxiliary water supply 54 may also be placed in the interior space 13 of the enclosure 12 to be used independently of the wash water supply vessel 46 or to refill the wash water supply vessel 46.

A bed 56 is mounted in the enclosure 12. The bed 56 is elongated and extends between the front side 19 and the back side 20 of the enclosure 12. The bed 56 comprises a main body 57 and an extension member 58 which is coupled to the main body 57. The extension member 58 is movable between a retraced position and a deployed position with respect to the main body 57. The extension member 58 extends from the main body 57 into the extension section 15 of the enclosure 12 when the extension section 15 of the enclosure 12 is in the extended position 17 and the extension member 58 of the bed 56 is in the deployed position 74. The extension member 58 is retracted into the main section 14 of the enclosure 12 when the extension member 58 is in the retracted position 72. The extension member 58 is pivotable with respect to the main body 57 but may be slidable or otherwise movably attached to the main body 57. A bed drawer 59 is mounted in the bed 56 adjacent to the back end of the enclosure 12. The bed drawer 59 is openable in a backward direction with respect to the enclosure 12. The bed 56 houses the shower reservoir 96 and the shower pump 98. The input 100 for the shower pump 98 is positioned adjacent to the bed drawer 59.

In use, a user may occupy the interior space 13 of the enclosure 12, including lying on the bed 56, operating the stove 28, using the wash system 38, and the like. The user may enter and exit through the access door assembly 80 over a tailgate 66 of the pickup truck 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A camper apparatus for a pickup truck, the camper apparatus comprising:
an enclosure defining an interior space therein, the enclosure being shaped and configured to conform to a truck bed of the pickup truck;
an access door assembly being coupled at a back side of the enclosure, the access door assembly being movable between a closed configuration and an open configuration with respect to an opening extending through the back side of the enclosure to the interior space, the access door assembly comprising an upper door which is pivotable upwardly with respect to the enclosure away from the opening of the enclosure;
a showerhead coupled to an interior side of the upper door of the access door assembly, the shower head being oriented to face downwardly when the upper door is spaced away from the opening of the enclosure;
a shower reservoir positioned in the interior space of the enclosure; and
a shower pump configured to selectively urge water from the shower reservoir to the showerhead.

2. The camper apparatus of claim 1, wherein the access door assembly further comprises a pair of gas springs coupled to and extending between the enclosure and the upper door, the pair of gas springs being configured to selectively retain the upper door away from the opening of the enclosure.

3. The camper apparatus of claim 1, wherein the access door assembly further comprises a lower door, the lower door being pivotable downwardly with respect to the enclosure away from the opening of the enclosure.

4. The camper apparatus of claim 3, wherein:
the enclosure comprises a main section which is sized and configured to fit between a cab of the pickup truck and a tailgate of the pickup truck when the tailgate is in an upright position, the extension section being slidable between a stored position in which the extension section is stored within the main section and an extended position in which the extension section extends rearwardly from the main section; and
the upper door of the access door assembly is mounted to the extension section of the enclosure, the lower door being mounted to the main section of the enclosure.

5. The camper apparatus of claim 1, wherein the enclosure comprises a main section which is sized and configured to fit between a cab of the pickup truck and a tailgate of the pickup truck when the tailgate is in an upright position, an upper portion of the main section of the enclosure being shaped and configured to rest atop and extend a full length of a pair of sidewalls of the truck bed.

6. The camper apparatus of claim 5, further comprising a plurality of windows coupled to the enclosure, each window of the plurality of windows being positioned on the upper portion of the main section of the enclosure, each one of a front side and a pair of lateral sides of the enclosure including an associated window of the plurality of windows.

7. The camper apparatus of claim 1, further comprising a flexible hose coupled to and extending between the shower pump and the showerhead.

8. The camper apparatus of claim 1, further comprising a pocket mounted to the interior side of the upper door.

9. The camper apparatus of claim 1, further comprising:
a stove mounted in the interior space of the enclosure; and
a stove cover mounted atop the stove, the stove cover being movable between a covered position and an open position, the stove cover being positioned to cover the stove when in the covered position, the stove cover being positioned to expose the stove when in the open position, the stove cover having a support surface which faces upwardly when the stove cover is positioned in the covered position.

10. The camper apparatus of claim 1, further comprising a wash system mounted in the interior space of the enclosure, the wash system comprising:
a sink defining a drain;
a faucet mounted over the sink;
a wash water supply vessel in fluid communication with the faucet, the wash water supply vessel being positioned below the sink, the faucet being operable to selectively allow water to flow from the wash water supply vessel through the faucet into the sink; and
a used water vessel in fluid communication with the drain of the sink, the used water vessel being positioned below the sink.

11. The camper apparatus of claim 10, further comprising a plurality of cabinets mounted in the enclosure, each one of the wash water supply vessel and the used water vessel being housed by an associated cabinet of the plurality of cabinets.

12. The camper apparatus of claim 1, wherein:
the enclosure comprises a main section which is sized and configured to fit between a cab of the pickup truck and a tailgate of the pickup truck when the tailgate is in an upright position, the extension section being slidable between a stored position in which the extension section is stored within the main section and an extended position in which the extension section extends rearwardly from the main section; and
further comprising a bed mounted in the enclosure, the bed being elongated and extending between the front side and the back side of the enclosure, the bed comprising a main body which fits within the main section of the enclosure and an extension member which is coupled to the main body, the extension member being movable between a retracted position and a deployed position with respect to the main body, the extension member extending from the main body into the extension section of the enclosure when the extension section of the enclosure is in the extended position and the extension member of the bed is in the deployed position, the extension member being retracted into the main section of the enclosure when the extension member is in the retracted position, the extension member being pivotable with respect to the main body.

13. The camper apparatus of claim 12, further comprising a bed drawer mounted in the bed, the bed drawer being openable in a backward direction with respect to the enclosure, the bed drawer being positioned adjacent to the back end of the enclosure.

14. A camper apparatus for a pickup truck, the camper apparatus comprising:
an enclosure defining an interior space therein, the enclosure being shaped and configured to conform to a truck bed of the pickup truck, the enclosure comprising a main section which is sized and configured to fit between a cab of the pickup truck and a tailgate of the pickup truck when the tailgate is in an upright position, an upper portion of the main section of the enclosure being shaped and configured to rest atop and extend a full length of a pair of sidewalls of the truck bed, the enclosure further comprising an extension section which is slidably coupled to the main section, the extension section being slidable between a stored position in which the extension section is stored within the main section and an extended position in which the extension section extends rearwardly from the main section, the main section being monolithically formed, the extension section being monolithically formed;
an access door assembly being coupled at a back side of the enclosure, the access door assembly being movable between a closed configuration and an open configuration with respect to an opening extending through the back side of the enclosure to the interior space, the access door assembly comprising an upper door and a lower door, the upper door being mounted to the extension section of the enclosure and being pivotable upwardly with respect to the enclosure away from the opening of the enclosure, the lower door being mounted to the main section of the enclosure and being pivotable downwardly with respect to the enclosure from the opening of the enclosure, the access door assembly further comprising a pair of gas springs coupled to and extending between the enclosure and the upper door, the pair of gas springs being configured to selectively retain the upper door away from the opening of the enclosure;
a showerhead coupled to an interior side of the upper door of the access door assembly, the shower head being oriented to face downwardly when the upper door is spaced away from the opening of the enclosure;
a shower reservoir positioned in the interior space of the enclosure;
a shower pump configured to selectively urge water from the shower reservoir to the showerhead;
a flexible hose coupled to and extending between the shower pump and the showerhead;
a pocket mounted to the interior side of the upper door;
a plurality of windows coupled to the enclosure, each window of the plurality of windows being positioned on the upper portion of the main section of the enclosure, each one of a front side and a pair of lateral sides of the enclosure including an associated window of the plurality of windows;
a stove mounted in the interior space of the enclosure;
a stove cover mounted atop the stove, the stove cover being movable between a covered position and an open position, the stove cover being positioned to cover the stove when in the covered position, the stove cover being positioned to expose the stove when in the open position, the stove cover having a support surface which faces upwardly when the stove cover is positioned in the covered position, the stove cover being pivotable between the covered position and the open position;
a wash system mounted in the interior space of the enclosure, the wash system comprising:
a sink defining a drain;
a faucet mounted over the sink;
a wash water supply vessel in fluid communication with the faucet, the wash water supply vessel being positioned below the sink, the faucet being operable to selectively allow water to flow from the wash water supply vessel through the faucet into the sink; and
a used water vessel in fluid communication with the drain of the sink, the used water vessel being positioned below the sink;
a plurality of cabinets mounted in the enclosure, each one of the wash water supply vessel and the used water vessel being housed by an associated cabinet of the plurality of cabinets;
a bed mounted in the enclosure, the bed being elongated and extending between the front side and the back side of the enclosure, the bed comprising a main body which fits within the main section of the enclosure and an extension member which is coupled to the main body, the extension member being movable between a retracted position and a deployed position with respect to the main body, the extension member extending from the main body into the extension section of the enclosure when the extension section of the enclosure is in the extended position and the extension member of the bed is in the deployed position, the extension member being retracted into the main section of the enclosure when the extension member is in the retracted position, the extension member being pivotable with respect to the main body; and
a bed drawer mounted in the bed, the bed drawer being openable in a backward direction with respect to the enclosure, the bed drawer being positioned adjacent to the back end of the enclosure.
